(19) United States
(12) Patent Application Publication
(10) Pub. No.: US 2006/0159063 A1
(43) Pub. Date: Jul. 20, 2006

(54) A System and Method for Businesses to advertise to receive and measure incoming Prospect Leads through a unique, empowered Independent Agent framework

(76) Inventor: Gopesh Kumar, Pleasanton, CA (US)

Correspondence Address: JEFFREY FURR, 253 N. MAIN STREET, JOHNSTOWN, OH, 43031, US

(21) Appl. No.: 10/905,744

(22) Filed: Jan. 19, 2005

(51) Int. Cl. H04L 12/66

(52) U.S. Cl. 370/352

(57) ABSTRACT

The present invention provides techniques for managing, supporting and empowering Independent Agents to offer a method for providing Clients with Phone Call Leads from Prospects generated via enabled Internet-based Advertisements, for monitoring and recording the precise details of these Phone Call Leads, and for charging those Clients for such successful Phone Call Leads. The present invention also provides the method and techniques for ensuring that Clients are only charged for successful incoming Phone Call Leads.

### BACKGROUND OF INVENTION

1. Field of the Invention

The present invention relates to techniques for managing, supporting and empowering Independent Agents to offer a method of advertising for generating and measuring incoming phone call Prospect Leads for Businesses by initiating and connecting the two parties (the Prospect and the Business) in real time from the Internet, for which the Independent Agents can charge Businesses. Further, the present invention provides the method and techniques for ensuring that the phone-based Prospect Lead is a successful connection.

2. Description of Prior Art

New Prospect Lead Generation services are currently offered through a variety of methods and techniques utilizing the telephone and/or the Internet. A business seeking new Prospect phone call leads can use a number of advertising platforms available on the Internet including banner advertisements, directory listings, ‘pay-per-click’ search engine listings to try to generate a new Prospect phone call lead. Likewise, any number of offline traditional advertising vehicles including a telephone book's yellow pages, for example, can be used by businesses to try to attract a new Prospect phone call lead.

But none of these advertising vehicles, online or off, can effectively monitor, track and log actual phone calls that are generated from these advertisements. They cannot definitively identify incoming calls to businesses that were generated from specific advertisements, and ensure that such calls are quality, successfully connected calls. Therefore, such advertising vehicles and Independent Advertising Agents lack the ability to provide a true measure of their actual effectiveness in terms of generating new Prospect phone call leads. Moreover, as a result of not being able to provide a true measure of performance, they are unable to offer businesses a performance-based phone call lead generation campaign.

Recently, there is a system available that offers businesses an Internet-based ‘pay-per-call’ platform. Although it offers a method to monitor and track incoming phone call leads from Internet-based advertising, it has many limitations and deficiencies. For example, the existing system rigidly defines the design of the advertising creative thereby eliminating Independent Advertising Agents' ability to create unique and attractive advertising media for their Clients. The existing system also controls and determines the distribution channels for advertisements, thereby limiting Independent Advertising Agents' flexibility to choose their own distribution and publishing partners or venues for their Clients' phone call lead generation campaigns. Additionally, the existing system does not distinguish between an incoming phone call lead through the system that does not successfully connect the Prospect to the Client and a phone call that does successfully connect the two parties, and therefore charges Clients even for unsuccessful calls. Further, the existing system employs a bidding mechanism with limited categories that requires Clients to constantly attend to their advertisements and oftentimes raise their per-call pay rate in order to ensure their advertisements are being displayed. Finally, the existing system does not provide a technique for Independent Advertising Agents to automatically share in the revenue generated from successful call leads from Prospects to Clients.

Consequently, there is a need for a system to enable the creation, implementation and monitoring of creatively-designed, flexibly-distributed Internet-based phone call lead generation campaigns that can safeguard against Clients' being inappropriately charged for unconnected phone calls, can allow Agents and Clients to set one price and maintain it for the duration of the campaign, and which provides the means for Independent Advertising Agents to run, manage and generate revenue from these campaigns. Such a system would overcome all of the limitations described in the previous paragraph. Just such a system, with its inventive framework and its creative methods, is hereinafter described.

### SUMMARY OF CURRENT INVENTION

It is the objective of the current invention to provide a system and methods for managing, supporting and empowering Independent Advertising Agents to offer a unique platform and service around a standard apparatus for enabling Clients to receive valuable incoming phone call leads from Prospects, for which the Agents are enabled to charge the Client a set pre-determined per call lead price, by connecting the Prospect and the Client in real time over the telephone but via an Internet-based interface. The present invention remedies the shortcomings of the prior art by ensuring the Client is only billed for successfully connected calls, by enabling Agents to incorporate the phone call initiating, tracking and billing system into their own creative advertising media, by empowering Agents to choose their own distribution channels for these enabled Advertising Creatives, by recording and displaying in real-time all phone call lead activity for the Client's and the Agent's ready access, by allowing for Agents and Clients to set firm pricing for an entire campaign without losing distribution display opportunities, and providing real-time reconciliation of revenue share for successful phone call lead fees from the Client to the Agent.

The benefits of this invention include the facilitation of real-time communication between a Prospect and a Client, the recording and displaying in real-time of all phone call lead activity for the Client and the Agent, the management of the accounting system for the Client and the Agent, the empowerment of Agents to freely develop and distribute their own customized web-based advertising media that integrates and utilizes the system thereby offering Clients more focused, differentiated and effective campaigns, and ultimately the ability for Clients to receive qualified, targeted and successful incoming phone call business inquiries from motivated and targeted Prospects. In general, the system provides a more flexible, efficient, comprehensive, practical, and functional method to enable Prospects to contact Clients for products and services they are interested in, and to empower Agents to provide the means and channels for Prospects to reach the Clients than the current art.

Definitions:

Advertisement or Advertising Creative (Web-based): a creative and unique design piece intended for distribution and display throughout the Internet for advertising purposes with the intention of encouraging consumers/prospects to take some consumer-related action as determined and desired by the Client, in this case an incoming phone call. Advertisements could include banner ads, landing pages, popup windows, emails, directory listings, etc.

Agent: one who integrates and employs the current system within their Internet-based advertising creatives and distributes and/or publishes these creatives throughout the Internet to drive phone call leads for their Clients.

Browser: a software program that runs on a client host and is used to request Web pages and other data from server hosts. This data can be downloaded to the client's disk or displayed on the screen by the browser.

Client: a person or business that employs the current invention through an Independent Agent with the intent of driving incoming phone call customer leads to their business.

Client host: a computer that requests Web pages from server hosts, and generally communicates through a browser program.

Content provider: a person or business responsible for providing the information that makes up a collection of Web pages.

Embedded client software programs: software programs that comprise part of a Web site and that get downloaded into, and executed by, the browser.

Host: a computer that is connected to a network such as the Internet. Every host has a hostname (e.g., mypc.mycompany.com) and a numeric IP address (e.g., 123.104.35.12).

HTML (HyperText Markup Language): the language used to author Web Pages.

In its raw form, HTML looks like normal text, interspersed with formatting commands. A browser's primary function is to read and render HTML.

HTTP (HyperText Transfer Protocol): protocol used between a browser and a Web server to exchange Web pages and other data over the Internet.

HyperText: text annotated with links to other Web pages (e.g., HTML).

Internet-Based Icon: a graphical or text icon that is linked to this system's database and enables the initiation of contact between the Service Provider and the consumer, which is located anywhere throughout the Internet including but not limited to websites, emails, directory listings, and advertisement banners

IP (Internet Protocol): the communication protocol governing the Internet.

Server host: a computer on the Internet that hands out Web pages through a Web server program.

Phone Call Lead: an incoming call from a Prospect to a Client through the system.

Phone-Link: a system-generated URL and sometimes icon that can be used to initiate, from the Internet, the connection of two parties over standard publicly-switched telephone lines.

Prospect: a potential customer for the Client.

URL (Uniform Resource Locator): the address of a Web component or other data. The URL identifies the protocol used to communicate with the server host, the IP address of the server host, and the location of the requested data on the server host. For example, “http://www.lucent.com/work.html” specifies an HTTP connection with the server host www.lucent.com, from which is requested the Web page (HTML file) work.html.

UWU server: in connection with the present invention, a special Web server in charge of distributing statistics describing Web traffic.

Visit: a series of requests to a fixed Web server by a single person (through a browser), occurring contiguously in time.

Web master: the (typically technically trained) person in charge of keeping a host server and Web server program running.

Web page: multimedia information on a Web site. A Web page is typically an HTML document comprising other Web components, such as images.

Web Publisher: a person or business that publishes web-based advertising for consumer visual impressions through a variety of web vehicles including but not limited to online content publications.

Web server: a software program running on a server host, for handing out Web pages.

Web site: a collection of Web pages residing on one or multiple server hosts and accessible through the same hostname (such as, for example, www.lucent.com).

### BRIEF DESCRIPTION OF DRAWINGS

Without restricting the full scope of this invention, the preferred form of this invention is illustrated in the following drawings:

FIG. 1 shows an overview of how prospects, Clients and Agents access the system through the Internet;

FIG. 2 shows system-based phone lead campaign process flow;

FIG. 3 shows the details of the successful call safeguard system;

FIG. 4 shows a sample of a Phone-Link enabled Advertising Creative;

FIG. 5 displays a summary page of an Agent's Usage Transactions in the system;

FIG. 6 displays a summary page of a Client's Usage Transactions in the system;

FIG. 7 displays the Agent's New Client Setup page interface;

FIG. 8 displays the Client's New Phone-Link Creation page interface; and

FIG. 9 displays the Successful Call Safeguarding system's Call Status definitions

### DETAILED DESCRIPTION

The following description is demonstrative in nature and is not intended to limit the scope of the invention or its application of uses.

There are a number of significant design features and improvements incorporated within the invention.

The current invention is a system that will allow Prospects to contact a Client on the phone in response to viewing and ‘clicking’ on an Agent-created and distributed advertisement on the Internet. The Prospects will choose to contact the Client by clicking on the appropriate link in the Advertisement. Once they choose to contact the Client, either the system will automatically call the Prospect and connect the call to the Client, or a pop-up window will appear prompting the Prospect to enter relevant information and then the system will connect the Prospect to the Client by telephone. The system provides the methods and techniques for Independent Advertising Agents to setup and design web-based system-enabled advertisements for Clients, and to monitor, record, and charge these Clients on a per phone call lead basis at the time when Prospects successfully connect with the Clients. Further, the present invention provides the method and techniques for ensuring that Clients are only charged when the Prospect-initiated system-generated phone call is determined to be a successful connection.

The computer and telecommunications application that includes the Prospect, Client and Agent interfaces for this invention will henceforth be referred to as “the System 1.” The System 1 is network based and works on an Internet, Intranet and/or Wireless network.

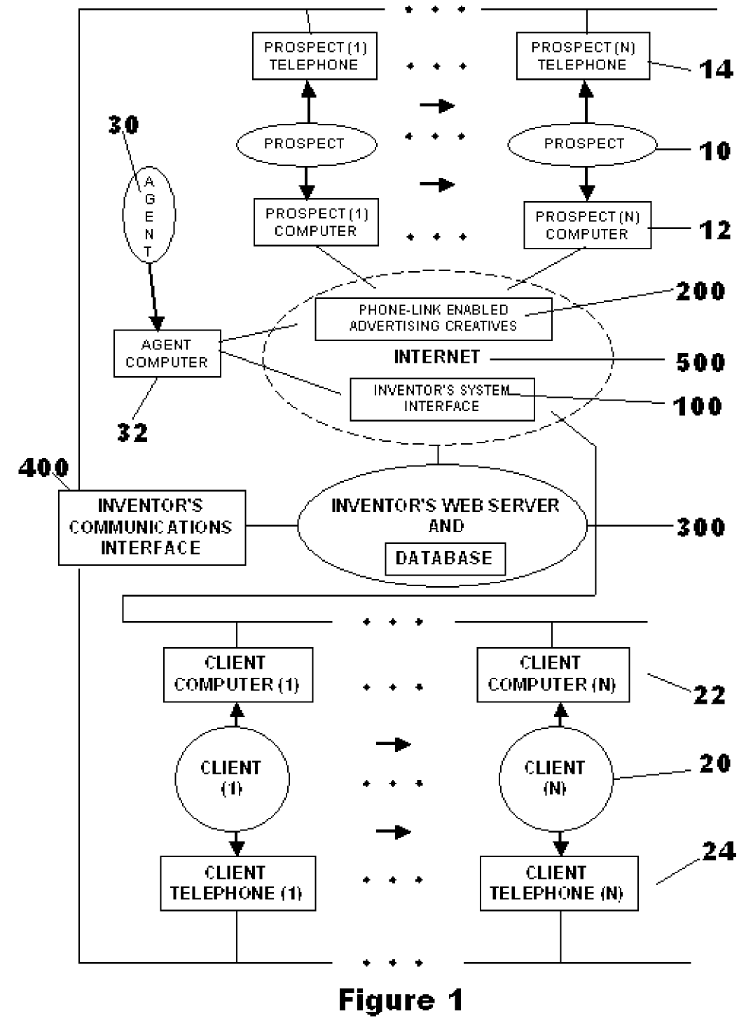

FIG. 1 illustrates a functional diagram of a computer network for World Wide Web (Internet) 500 access to the System 1 by a plurality of Prospects 10 who access the System Web Server and Database 300 and the Communications Interface 400 via the Internet-based System-enabled Advertisements 200 created by the Agent 30 from the Prospects' Computers 12 and Telephones 14 in order contact a plurality of Clients 20 via the Clients' Telephones 24. Accessing the Advertising Creatives 200 can be accomplished directly through a communication means such as a direct connection, an intranet, a local Internet Service Provider, often referred to as ISPs, or through an on-line Service Provider like CompuServe, Prodigy, American Online, etc. or Wireless devices using services like AT&T or Verizon.

The Prospects 10 contact the System Web Server and Database 300 via the Advertising Creatives 200, and the Agents 30 and Clients 20 contact System Web Server and Database 300 via the System Interface 100 using an informational processing system (Client) capable of running an HTML compliant Web browser such as Microsoft's Internet Explorer, Netscape Navigator, Lynx and Mosaic. A typical system that is used is a personal computer with an operating system such as Windows 95, 98 or ME, NT, 2000 or Linux, running a Web browser. The exact hardware configuration of computer used by the Prospects 10, the brand of operating system or the brand of Web browser configuration is unimportant to understand this present invention. Those skilled in the art can conclude that any HTML (Hyper Text Markup Language) compatible Web browser is within the true spirit of this invention and the scope of the claims.

In one preferred embodiment of the invention, per FIG. 1, the Agents 30 and Clients 20 will be able to connect to the System Interface 100 via the Internet 500 using their respective Computers 32 and 22 to register their accounts; and Prospects 10 will be able to connect to the Advertising Creatives 200 or the System Interface 100 via the Internet 500 using their respective Computers 12 to initiate a phone call. In the preferred embodiment the System Interface 100 has numerous web pages. The information in the web pages is in HTML format via the HyperText Transport Protocol (http) and on the Server System 300. The System will allow the viewing of web pages and the inputting of Prospect 10, Agent 30 and Client 20 information to be stored in the System Database 300, through commonly used software referred to as a Web Browser, such as Communicator available from Netscape Communications Corp. or Internet Explorer available from Microsoft Corp. The system is capable of accessing web pages located on Server System 300.

The System 1 will provide the ability for Agents 30 to embed Internet-based Icons within the Advertisements 200 they will have created for Clients 20 that will be empowered to access the System Web Server Database 300. From these Advertisements 200, Prospects 10 will then be enabled to contact the Agents' Clients 20.

The System 1 will connect the Prospect 10 and the Client 20 using the Communication Interface 400. In the preferred embodiment, once a Prospect 10 decides to contact a Client 20, the Communication Interface 400 will call both the Prospect 10 and the Client 20 to connect them providing the opportunity for the Client 20 to turn the new Prospect 10 into a customer. The Communication Interface 400 will call the Prospect's telephone 14 and the Client's telephone 24. This communication can also be done over the Internet or an instant messenger system.

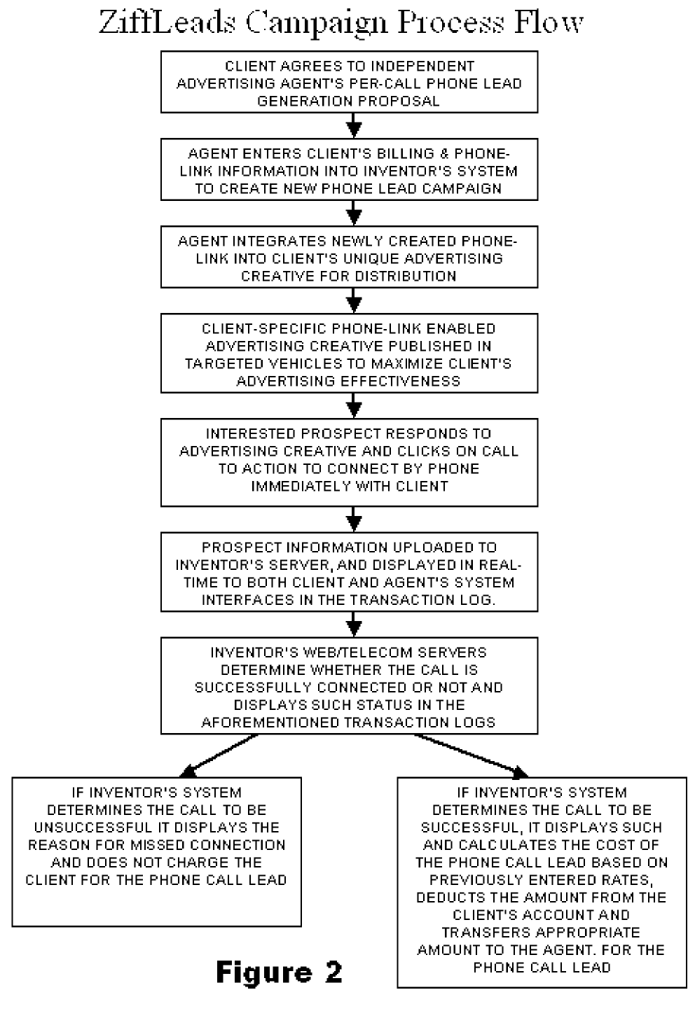

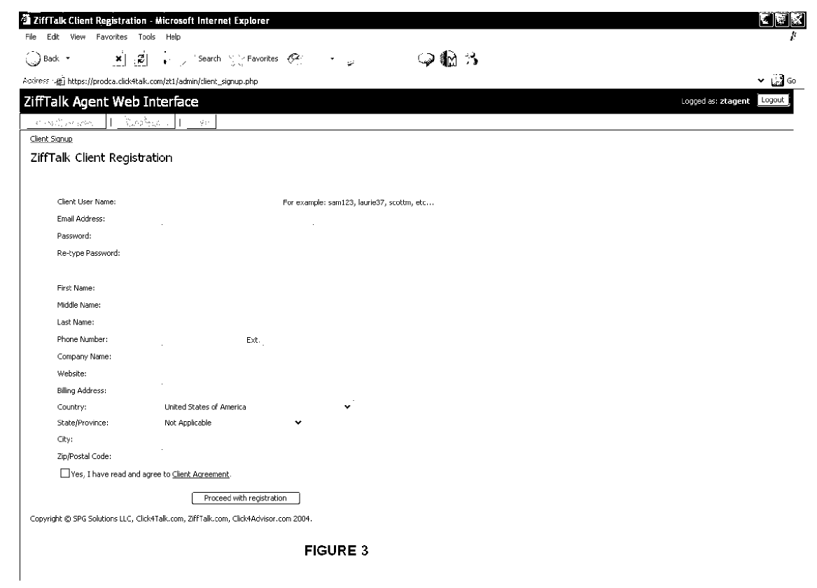

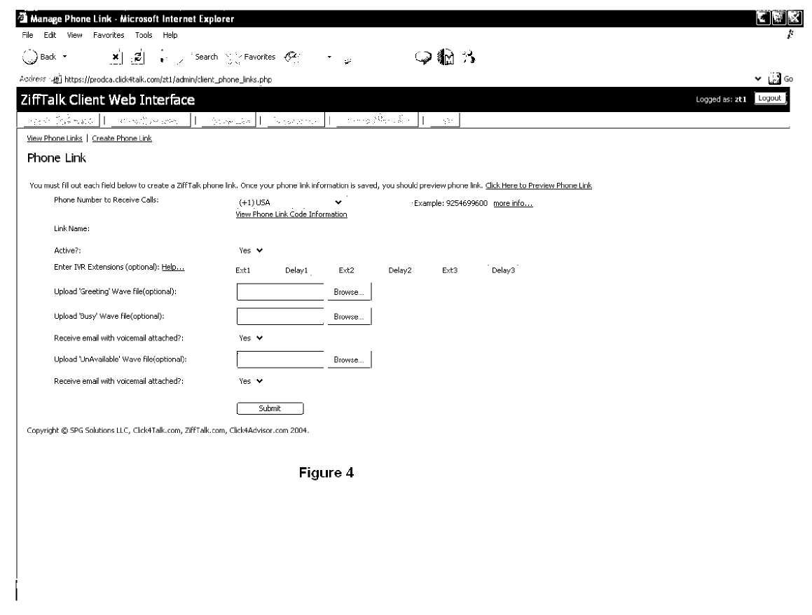

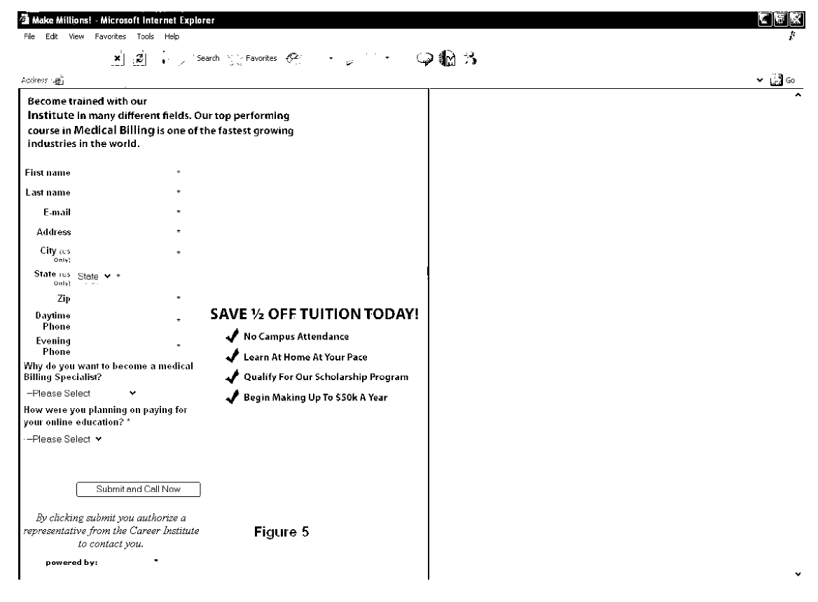

In one preferred embodiment of the invention, per FIG. 2's Process Flow, Agents 30 will be registered with the System 1 and will be assigned an Agent ID Name for their Agent 30 accounts. Agents 30 will connect to the System 1 via the System Interface 100 to access their accounts. Within the Agent System Interface 300, the Agent 30 will register a new Client 20 per FIG. 3, entering the Client's account and billing information into the System 1, and making an initial deposit into the Client account. The Agent 30 will then create a new Phone Link into the System 1 for the Client's 20 advertising campaign, per FIG. 4, will set the pre-determined per phone call lead price into the System 1, and will embed the Phone Link into the Client-specific Advertising Creative 200. An example of such a System-enabled Advertisement 200, in this case a landing page form for an online educational site, is shown in FIG. 5.

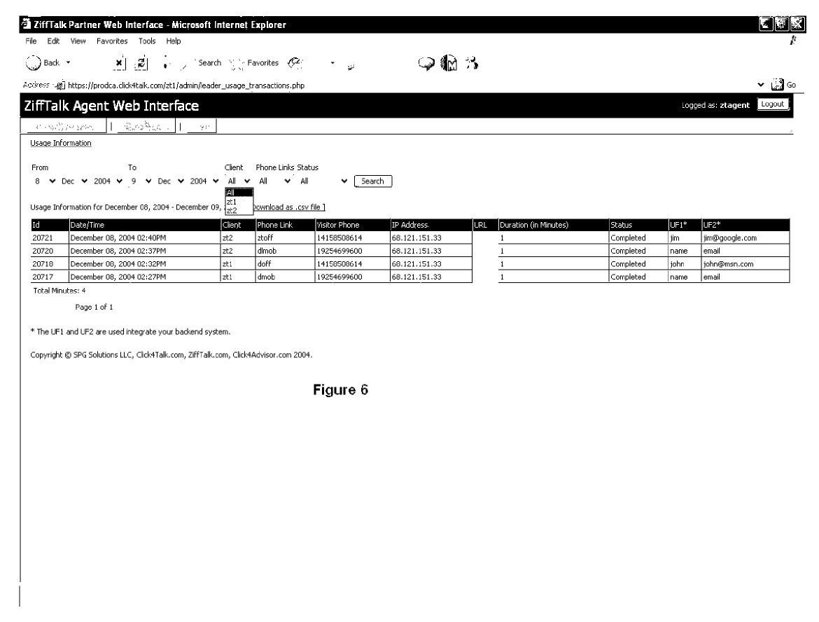

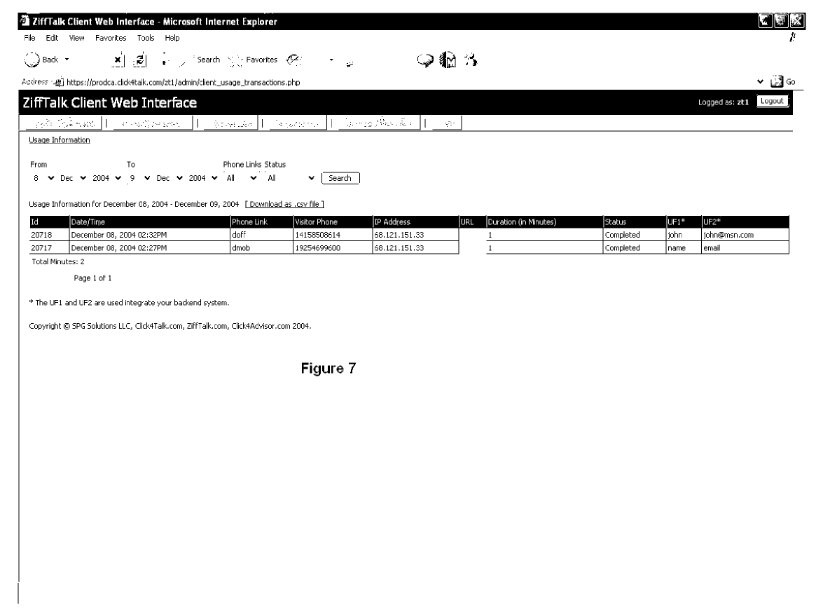

In this preferred embodiment, an interested Prospect 10 will complete the Advertising form 200 and click on the “Submit and Call Now” call to action button in the Creative 200. At this moment, the Prospect's 10 relevant information will be uploaded to the System 1 server and displayed in the Agent's 30 and Client's 20 Transaction Logs of their respective System Interfaces 100 as a new record with the call status identified as ‘In Process’. Examples of the System 1 Transactions Logs are shown in FIG. 6 for the Agent 30 interface and FIG. 7 for the Client 20 interface. The Transaction Log records will include the unique Phone Call Lead ID number, the Date and Time when the call is initiated by a Prospect 10, the general Client ID Name to whom the Call Lead is connected (in the case of the Agent interface), the unique specific Phone Link ID Name to which the Call Lead is connected, the Prospect's 10 phone number, the Prospect's IP address, the web page URL from which the Prospect 10 initiated the call, the Duration of phone call connection, the Status of the Call Lead (discussed in more detail below), and the UF1 (User Field 1) and UF2 (User Field 2), which are additional variable identifiers regarding the Prospect 10 which Agents 30 are empowered by the System 1 to pass through into the System Interface 100 for Client 20 or Agent 30 reference. Furthermore, the System 1 will display more relevant information regarding the Phone Call Leads per the requirements of Agents and Clients. In addition, the System Interfaces 100 will have selection criteria for the records to display thereby enabling Agents and Clients to view records per their selected parameters.

Concurrently, in this preferred embodiment, the System's 1 Communications Interface 400 will receive the command from the Prospect 10 and initiate a telephone call to the Prospect's 10 inputted telephone number. The Prospect 10 will answer the telephone upon receiving the call. The Client's 20 optional customized ‘greeting’ message will be played for the Prospect 10 from the system's Communications Interface 400. The system's Communications Interface 400 will then initiate a telephone call to the Client's phone number associated with the Phone-Link created in the system database 300 previously. The Client 20 will answer the telephone upon receiving the call. The Communications Interface 400 then will connect the Client 20 with the Prospect 10 to begin a successful incoming phone Call Lead.

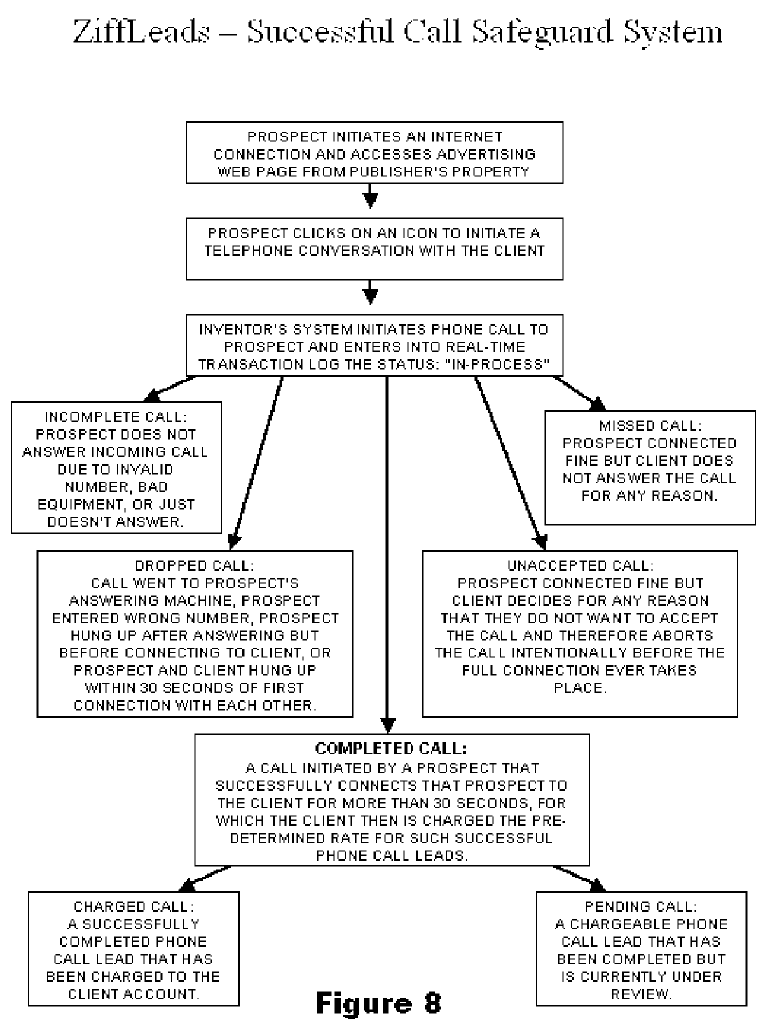

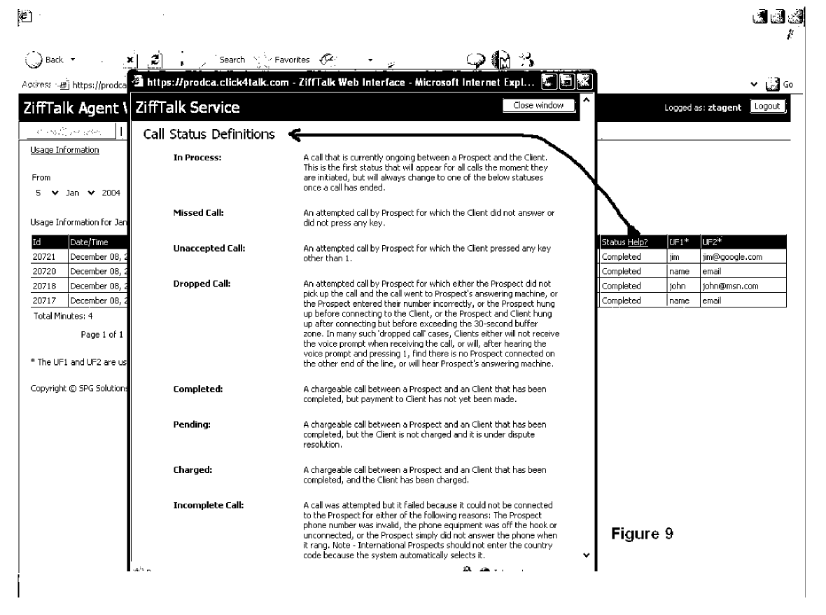

The System 1 is capable of determining whether a Call Lead initiated by a Prospect 10 ultimately becomes a successfully completed connection between that Prospect 10 and the Client 20. In the preferred embodiment of the invention, the System 1 does this by monitoring the activity of each individual phone Call Lead in the Communications Interface 400, defining and identifying various different call Statuses, updating the Call Statuses as appropriate into the System Interface 300, and then charging the Client 20 only for those Call Leads deemed ultimately ‘successful’. FIG. 8 displays the process flow of the System's 1 Successful Call Safeguard System, while FIG. 9 shows the Call Status column and definitions found in the System Interface 300.

In this preferred embodiment, when a Prospect 10 first initiates contact to the Client 20 through the System 1, the System 1 registers the ‘In Process’ status into the Interface 300, which notifies Clients 20 and Agents 30 that a call has been initiated, attempted and is ongoing between the Client 20 and Prospect 10. The status remains ‘In Process’ while the call is in progress. Once the call completes, the status will change to one of five (5) statuses, as shown in FIG. 8.

The System 1 recognizes four (4) different status-causes for ‘unsuccessful’ Call Leads. The first is the ‘Incomplete Call’, which occurs as a result of an issue with the Prospect's 10 telephone number or equipment preventing the first leg of the connection to the Prospect-side from completing. The second is the ‘Dropped Call’, which indicates that although both legs of the call are completed, the Prospect-side ‘drops’ the call either before it is connected to the Client 20 or within 30 seconds of the connection with the Client 20. The third is a ‘Missed Call’, which indicates that the Prospect-leg of the call is connected successfully, but that the call can not be connected to the Client 20. The fourth status-cause for ‘unsuccessful’ Call Leads is the ‘Unaccepted Call’, which indicates that the Prospect connected successfully but then the Client intentionally chooses to not accept the call thereby aborting the call before the full connection occurs.

If none of the ‘unsuccessful’ Call Lead statuses occur and instead, the Call Lead is connected successfully between the Prospect 10 and the Client 20 for over thirty (30) seconds and is then completed, the Call Lead is considered ‘successful’ and the status for such a Call Lead becomes ‘Completed’. The Client 20 then becomes liable for the per-Call Lead charges assigned to their campaign and inputted into the System 1.

Further statuses related to the financial transactions of the per Call Lead charges follow after the ‘Completed’ call status. The first of these statuses is ‘Charged’, which indicates the System 1 has charged the Client 20 for the successful Call Lead, and is a final status. The second status is ‘Pending’, which indicates the System 1 has not yet charged the Client 20 for the successful Call Lead, pending further review of the Call Lead information. The ‘Pending’ status will ultimately become either a final ‘Charged’ status, or one of the ‘unsuccessful’ final statuses.

In a preferred embodiment of the Invention, the Agent 30 will enter Client 20 account and billing information into the System Server 300 via the System Interface 100. The Agent 30 will create the Client 20 Phone Link into the System 1, per FIG. 4, will set the per Call Lead rate, and the System 1 will forward the appropriate HTML code for the Phone Link to the Agent 30 to allow the Agent to embed the Client Phone Link into the Client-specific Advertising Creative 200. All these features help the Agent 30 better manage their Call Lead generation campaigns for their Clients 20.

In the preferred embodiment, Successful Call Leads to the Client 20 will be charged by the System 1 the pre-determined per Call Lead rate. The System 1 will automatically deduct the charges from the Client's 20 System account and transfer appropriate payment to the Agent 30 account. The details of the charges and financial transactions to the Client 20 will be displayed in the Client's System Interface 100. These same details, as well as the details of the Agent's income related to all their Call Lead campaigns will be displayed in the Agent's System Interface 100. In addition, these screens will have selection criteria for the records to display.

The system 1 is set to run on a computing device. A computing device on which the present invention can run would be comprised of a CPU, Hard Disk Drive, Keyboard, Monitor, CPU Main Memory and a portion of main memory where the system resides and executes. Any general-purpose computer with an appropriate amount of storage space is suitable for this purpose. Computer Devices like this are well known in the art and are not pertinent to the invention. The system 1 is set to run on telecommunications sets. Telecommunications sets can include standard landline telephone sets utilizing the Publicly Switched Telephone Network (PSTN) or any variations thereof, any kind of cellular telephone set utilizing any cellular call processing technology, as well as any telecommunications sets utilizing Voice over Internet Protocol (VoIP) voice communications technology. Telecommunications sets like this are well known in the art and are not pertinent to the invention. The system 1 can also be written in a number of different languages and run on a number of different operating systems and platforms.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A method of connecting two parties in real time, the method comprising:
having an Agent have a plurality of Clients and Client advertising campaigns;
having a Prospect initiate contact with a Client via an Agent-created Advertisement; and
connecting by telephone said Prospect with said Client.

2. The method as described in claim 1, further comprising: generating said telephone connection directly from a prompt to a Prospect within an Internet-based Advertisement.

3. The method as described in claim 2, further comprising capturing Prospect phone number information directly from the Advertisement form upon Prospect's prompt, and thereby enabling said connection.

4. The method as described in claim 1, further comprising having the system empower said Agent to create and integrate Phone-Links into their Clients' advertising campaigns.

5. The method as described in claim 4, further including an interface for said Agent to enter relevant Client information, including the per-Phone Call Lead set pricing information.

6. The method as described in claim 4, further comprising having the system automatically generate and provide said Agent the appropriate custom HTML code required to integrate Client campaign-specific Phone-Links into their Clients' advertising campaigns, and thereby providing Agents with the flexibility to choose their own advertisement distribution channels.

7. The method as described in claim 1, further including an interface for said Clients to view, monitor and manage their Advertising campaigns.

8. The method as described in claim 7, further including a real-time Phone Call Lead transaction log for said Clients to view that displays relevant and customized Client information immediately upon the initiation of said telephone connection.

9. The method as described in claim 1, further comprising having the system manage Phone Call Lead activity and transaction records for said Agent's Client advertising campaigns.

10. The method as described in claim 9, further including reporting said Phone Call Lead activity and transaction records.

11. The method as described in claim 9, further comprising calculating the number of successful said Phone Call Leads and duration of each telephonic connection, and the resultant amount owed by the Client, based on the number of Phone Call Leads multiplied by the agreed upon Phone Call Lead price.

12. The method as described in claim 11, further comprising deducting the amount owed by the Client from the Client account balance.

13. The method as described in claim 11, further comprising paying the Agent the amount due based on their Client campaigns' Phone Call Lead transactions activity.

14. A method of connecting two parties in real time, the method comprising providing an Agent interface to Agents for their account; having Agents register new Client Phone-Link enabled Internet-based advertising campaigns within the Agent interface; linking all enabled Client advertising campaigns developed by a single Agent into one account information and transaction activity management interface; generating and providing the appropriate service HTML code to the Agent for each newly registered Client campaign; providing a Client interface to Clients for their advertising campaigns; thereby enabling the Agent to readily create own Phone Call Lead-generating Internet-based Advertisements for their Clients and in turn, and connecting Prospects with these Clients in real time via a telephone connection; thereby generating, monitoring and recording Phone Call Leads for Clients from various Internet advertising media.

15. The method as described in claim 14, further comprising allowing for said Prospects to remain in effect on the Advertisement created by said Agent for Client while using the system for connecting telephonically to Client, by way of a fully integrated automatic dialing system.

16. The method as described in claim 14, further comprising monitoring incoming Phone Call Leads and collecting and displaying in real-time relevant Prospect information for both the Client and the Agent in their respective system interfaces.

17. A method of connecting two parties in real time, the method comprising:
identifying and recording when an incoming call is initiated; identifying and recording when an incoming call is dropped on the Prospect's leg before connecting with said Client; identifying and recording when an incoming call is missed by a Client after the Prospect has been connected; identifying and recording when an incoming call is disconnected within a given buffer-zone time period after the connection is made between said Prospect and Client; identifying and recording when an incoming call is successfully connected between the Prospect and the Client, lasts beyond the given buffer-zone time period, and then is completed; and charging the Client only for incoming Phone Call Leads that were successfully connected and completed for a duration beyond said buffer zone; thereby ensuring that Clients are only charged for successful incoming Phone Call Leads.
